(19) United States
(12) Patent Application Publication
(10) Pub. No.: US 2013/0004159 A1
(43) Pub. Date: Jan. 3, 2013

(54) CONTROL DEVICE, OPTICAL RECEIVING DEVICE, AND CONTROL METHOD

(75) Inventors: Takahiro MAKIMOTO, Sapporo (JP); Noriaki Mizuguchi, Sapporo (JP)

(73) Assignee: FUJITSU LIMITED, Kawasaki-shi (JP)

(21) Appl. No.: 13/482,379

(22) Filed: May 29, 2012

(30) Foreign Application Priority Data
Jun. 28, 2011 (JP) 2011-143272

(51) Int. Cl. G05B 13/02; H04B 10/06; H04B 10/08

(52) U.S. Cl. 398/25; 700/40

(57) ABSTRACT

A control device includes: a first computing circuit which manipulates a parameter that changes a first characteristic in a processing device on the basis of a result of detecting the first characteristic of the processing device; an updating control circuit which stops the first computing circuit from manipulating the parameter when updating a function of the first computing circuit; an acquisition circuit which acquires relationship information indicating a relationship between an amount to be manipulated for the parameter and the amount of change in a second characteristic of the processing device that changes the first characteristic; and a second computing circuit which manipulates the parameter by an amount to be manipulated based on the relationship information acquired by the acquisition circuit and the amount of change in a result of detecting the second characteristic, while the first computing circuit is stopped from manipulating the parameter by the updating control circuit.

### CROSS REFERENCE TO RELATED APPLICATION

This application is based upon and claims the benefit of priority from the prior Japanese Patent Application NO. 2011-143272 filed on Jun. 28, 2011, the entire contents of which are incorporated herein by reference.

### FIELD

The embodiments disclosed hereafter are related to a control device, an optical receiving device, and a control method which control a characteristic.

### BACKGROUND

For example, FWDL (Firmware Download) is known, which allows a function of a computing unit (computing circuit) included in a processing device of, for example, a communication device to be updated during operation of the processing device. Computing units to be updated are programmable devices, such as a PLD (Programmable Logic Device), an FPGA (Field Programmable Gate Array), and a CPU (Central Processing Unit). Such a computing unit is used in, e.g., feedback control for compensating for a characteristic in a processing device.

A configuration is also known which uses feedback control and feedforward control in combination to compensate for a characteristic in a processing device. For example, a configuration in, e.g., a control structure of an optical amplifier module is known which performs feedforward control to compensate for rapid fluctuations difficult to control by feedback control alone.

Feedback control, for example, detects a characteristic to be compensated for and adjusts a manipulation value which changes the characteristic to be compensated for on the basis of a result of the detection. Feedforward control, for example, detects a characteristic of, e.g., a disturbance which changes a characteristic to be compensated for and adjusts a manipulation value which changes the characteristic to be compensated for on the basis of a result of the detection.

For example, if a function of a computing unit which performs feedback control is updated during operation of a processing device, the feedback control may be suspended to prevent a manipulation value from changing transiently to an unexpected value. For example, if the computing unit to be updated is of large scale or if the computing unit is updated by downloading a definition file, the updating is time-consuming and may request, e.g., about several tens of seconds.

Examples of a processing device using feedback control include a coherent optical receiving device which receives signal light. For example, a coherent optical receiving device is known which is adapted to adjust the frequency of local oscillation light by feedback control in order to compensate for the phase difference between signal light and the local oscillation light.
[Patent Document 1] Japanese Laid-Open Patent Publication No. 2009-135930
[Patent Document 2] Japanese Laid-Open Patent Publication No. 2010-109847
[Patent Document 3] Japanese Laid-Open Patent Publication No. 2009-253971
[Patent Document 4] Japanese Laid-Open Patent Publication No. 2009-49613

The above-described conventional technique, however, may be unable to compensate for variations in characteristic due to, e.g., a disturbance just by feedforward control with a larger error (e.g., systematic error), if a computing unit which performs feedback control is stopped. This results in the problem of inability to stabilize control of a characteristic of a processing device when a function of a computing unit which performs feedback control is updated.

### SUMMARY

According to an aspect of the embodiments, there is provided a control device includes: a first computing circuit which manipulates a parameter that changes a first characteristic in a processing device on the basis of a result of detecting the first characteristic of the processing device; an updating control circuit which stops the first computing circuit from manipulating the parameter when updating a function of the first computing circuit; an acquisition circuit which acquires relationship information indicating a relationship between an amount to be manipulated for the parameter and the amount of change in a second characteristic of the processing device that changes the first characteristic; and a second computing circuit which manipulates the parameter by an amount to be manipulated based on the relationship information acquired by the acquisition circuit and the amount of change in a result of detecting the second characteristic, while the first computing circuit is stopped from manipulating the parameter by the updating control circuit.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF THE DRAWINGS

FIG. 1 is a diagram depicting a configuration example of a control device according to a first embodiment;

FIG. 2 is a flow chart depicting an example of updating control by an updating control circuit;

FIG. 3A is a chart depicting an example of a control state when a first computing unit is in operation;

FIG. 3B is a reference chart depicting an example of a control state in a case where control by a second computing unit is not changed when the first computing unit is not in operation;

FIG. 3C is a chart depicting an example of a control state in a case where control by the second computing unit is changed when the first computing unit is not in operation;

FIG. 4 is a flow chart depicting a modification of the updating control by the updating control circuit;

FIG. 5 is a diagram depicting a configuration example of an optical receiving device according to a second embodiment;

FIG. 6 is a chart depicting an example of a characteristic of an LD;

FIG. 7 is a flow chart depicting a first example of updating control by an updating control circuit;

FIG. 8 is a flow chart depicting a second example of the updating control by the updating control circuit;

FIG. 9 is a diagram depicting a configuration example of an optical receiving device according to a third embodiment;

FIG. 10 is a chart depicting an example of a characteristic of optical phase versus temperature of an optical phase adjusting element; and

FIG. 11 is a diagram depicting a modification of the optical receiving device depicted in FIG. 9.

### DESCRIPTION OF EMBODIMENTS

Embodiments of a control device, an optical receiving device, and a control method according to the present invention will be described below in detail with reference to the accompanying drawings.

### First Embodiment

### Configuration Example of Control Device

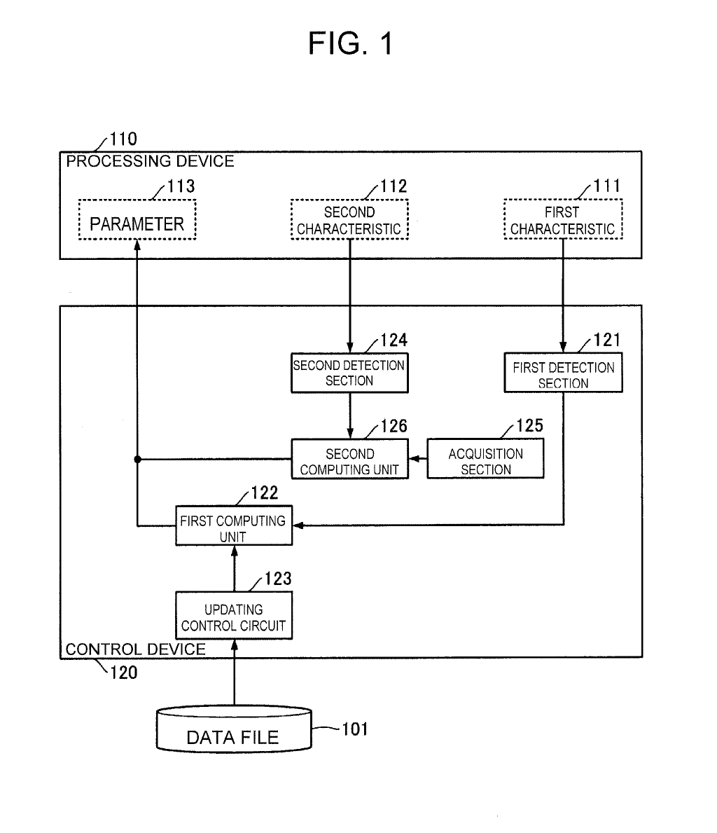

FIG. 1 is a diagram depicting a configuration example of a control device according to a first embodiment. A control device 120 depicted in FIG. 1 is a control device which compensates for fluctuations in a first characteristic 111 of a processing device 110 by manipulating a parameter 113 of the processing device 110. More specifically, the control device 120 includes a first detection section 121, a first computing unit 122, an updating control circuit 123, a second detection section 124, an acquisition section 125, and a second computing unit 126.

The first detection section 121 detects the first characteristic 111 of the processing device 110. The first characteristic 111 is a characteristic to be controlled (to be compensated for) by the control device 120. The first detection section 121 outputs a result of detecting the first characteristic 111 to the first computing unit 122.

The first computing unit 122 performs feedback control that manipulates the parameter 113 of the processing device 110 on the basis of the result of detecting the first characteristic 111 output from the first detection section 121. For example, the first computing unit 122 increases or decreases the parameter 113 by outputting a manipulation value giving instructions to manipulate the parameter 113 to the processing device 110.

The parameter 113 is a parameter which changes the first characteristic 111. The parameter 113 may include a plurality of parameters (e.g., a first parameter and a second parameter) which change the first characteristic 111. For example, the first computing unit 122 repeatedly changes the parameter 113 until the result of detecting the first characteristic 111 falls within a predetermined range.

The first computing unit 122 is a programmable device, such as a PLD, an FPGA, or a CPU, whose function may be externally updated. More specifically, the first computing unit 122 may update its function by the updating control circuit 123 applying a new data file to the first computing unit 122.

The updating control circuit 123 is an updating control section which updates the function of the first computing unit 122. Updating of the function of the first computing unit 122 refers to, e.g., adjustment of an algorithm and data used in computation by the first computing unit 122. The updating control circuit 123 stops the first computing unit 122 from controlling the parameter 113 when updating the function of the first computing unit 122. For example, the updating control circuit 123 fixes the manipulation value for the parameter 113 to be manipulated by the first computing unit 122.

The updating control circuit 123 updates the function of the first computing unit 122 by, for example, downloading a data file 101 over a network and applying the downloaded data file 101 to the first computing unit 122. Alternatively, the updating control circuit 123 may update the function of the first computing unit 122 by reading the data file 101 stored in a storage medium and applying the read data file 101 to the first computing unit 122. Alternatively, the updating control circuit 123 updates the function of the first computing unit 122 via an I²C (MICROWIRE) interface capable of serial communication.

The second detection section 124 detects a second characteristic 112 of the processing device 110. The second characteristic 112 is a characteristic of the processing device 110 which is different from the first characteristic 111 and is a characteristic which changes the first characteristic 111 (acts on the first characteristic 111). The second characteristic 112 may include a plurality of characteristics (e.g., a third characteristic and a fourth characteristic) which change the first characteristic 111. The second detection section 124 outputs a result of detecting the second characteristic 112 to the second computing unit 126.

The acquisition section 125 acquires relationship information indicating the relationship between an amount to be manipulated (which may have a negative value) for the parameter 113 and the amount of change in the second characteristic 112 (which may have a negative value). An example of the relationship information is information (a function) indicating the ratio of the manipulation value for the parameter 113 to the second characteristic 112. Alternatively, the relationship information may be a table or the like in which the amount to be manipulated for the parameter 113 and the amount of change in the second characteristic 112 are associated with each other.

For example, the relationship information is stored in a memory of the control device 120. The acquisition section 125 acquires the relationship information from the memory. Alternatively, the acquisition section 125 may acquire the relationship information from the outside (e.g., the updating control circuit 123) when the second computing unit 126 is in operation. Note that the acquisition section 125 may be implemented together with the second computing unit 126 by a single circuit.

The second computing unit 126 compensates for fluctuations in the second characteristic 112 by high-accuracy feedforward control while the first computing unit 122 is stopped from controlling the parameter 113 by the updating control circuit 123. The accuracy of feedforward control refers to the level of an error which may occur in a value controlled under certain conditions and is a measure of proximity to a target value for control. More specifically, the second computing unit 126 manipulates the parameter 113 by an amount to be manipulated based on the relationship information acquired by the acquisition section 125 and the amount of change in the result of detecting the second characteristic 112 output from the second computing unit 126. For example, the second computing unit 126 manipulates the parameter 113 by outputting the manipulation value giving instructions to manipulate the parameter 113 to the processing device 110.

More specifically, the second computing unit 126 derives an amount to be manipulated for the parameter 113 that compensates for the amount of change in the result of detecting the second characteristic 112 on the basis of the relationship information. The second computing unit 126 manipulates the parameter 113 by the derived amount to be manipulated. For example, if the result of detecting the second characteristic 112 increases by Δ1, the second computing unit 126 derives an amount Δ2 to be manipulated which decreases the second characteristic 112 by Δ1 on the basis of the relationship information. The second computing unit 126 manipulates the parameter 113 by the derived amount Δ2 to be manipulated.

With this operation, the second characteristic 112 decreases by Δ1 and returns to the original value. The use of the relationship information allows derivation of an amount to be manipulated for the parameter 113 which compensates for the amount of change in the second characteristic 112. It is thus possible to manipulate the parameter 113 under high-accuracy control and compensate for fluctuations in the second characteristic 112.

Accordingly, even while control by the first computing unit 122 is stopped, the second computing unit 126 may suppress fluctuations in the second characteristic 112 which changes the first characteristic 111 to suppress fluctuations in the first characteristic 111. Note that when control by the first computing unit 122 is not in abeyance, the second computing unit 126 may perform control using the relationship information or may perform control without the relationship information. For example, the second computing unit 126 performs, as control without the relationship information, control that repeatedly changes the parameter 113 until the result of detecting the second characteristic 112 falls within a predetermined range.

If the parameter 113 includes a plurality of parameters (e.g., the first parameter and the second parameter), the second computing unit 126 manipulates at least one of the plurality of parameters included in the parameter 113. In this case, the acquisition section 125 acquires relationship information for each of the plurality of parameters included in the parameter 113.

As described above, the control device 120 uses the relationship information between a detected value and a manipulation value in feedforward control to be performed by the second computing unit 126 during updating of the function of the first computing unit 122 that performs feedback control. This allows an improvement in the accuracy of feedforward control and stabilization of control of the first characteristic 111 during updating of the first computing unit 122.

### (Updating Control by Updating Control Circuit)

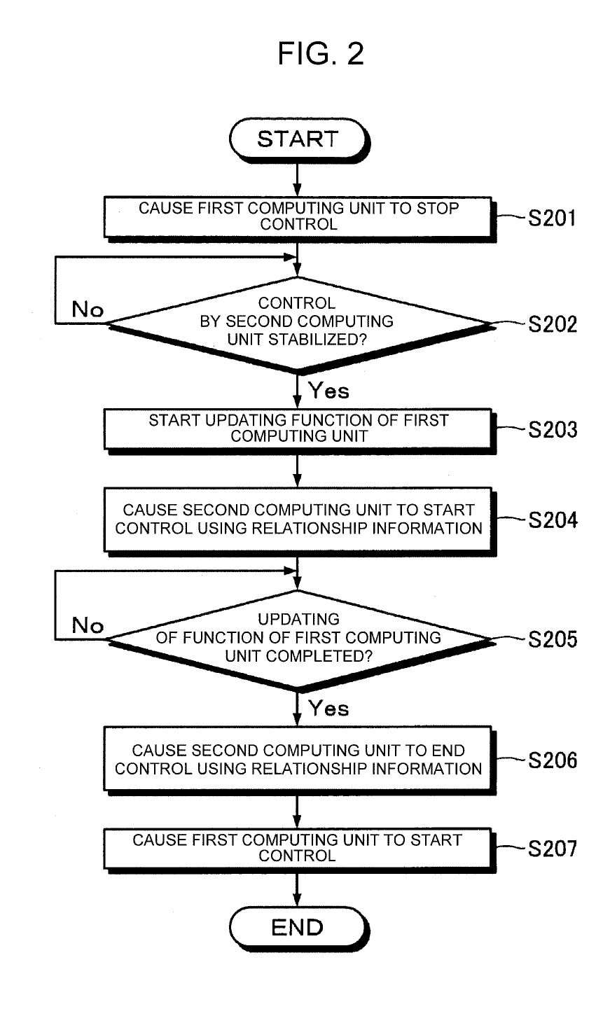

FIG. 2 is a flow chart depicting an example of updating control by the updating control circuit. The updating control circuit 123 executes, for example, the steps depicted in FIG. 2 when updating the function of the first computing unit 122. Assume here that the second computing unit 126 performs control using the relationship information when the first computing unit 122 is not in operation and does not perform control using the relationship information when the first computing unit 122 is in operation. First, the updating control circuit 123 causes the first computing unit 122 to stop control (step S201). More specifically, the updating control circuit 123 causes the first computing unit 122 to hold the manipulation value to be output.

The updating control circuit 123 determines (step S202) whether control by the second computing unit 126 has been stabilized. For example, the updating control circuit 123 acquires the manipulation value output from the second computing unit 126 at fixed time intervals and calculates the amount of change in the acquired manipulation value. If the amount of change is higher than a threshold value, the updating control circuit 123 determines that control by the second computing unit 126 has not been stabilized. On the other hand, if the amount of change is not more than the threshold value, the updating control circuit 123 determines that control by the second computing unit 126 has been stabilized.

In step S202, the updating control circuit 123 waits (No loop in step S202) until control by the second computing unit 126 is stabilized. When control by the second computing unit 126 has been stabilized (Yes in step S202), the updating control circuit 123 starts updating the function of the first computing unit 122 (step S203). The updating control circuit 123 then causes the second computing unit 126 to start control using the relationship information (step S204).

The updating control circuit 123 determines (step S205) whether the updating of the function of the first computing unit 122 that is started in step S203 is completed and waits (No loop in step S205) until the updating of the function of the first computing unit 122 ends. When the updating of the function of the first computing unit 122 is completed (Yes in step S205), the updating control circuit 123 causes the second computing unit 126 to stop control using the relationship information (step S206).

The updating control circuit 123 then causes the first computing unit 122 to start control (step S207) and ends the series of updating control operations. The above-described steps make it possible to update the function of the first computing unit 122 while controlling the first characteristic 111. During updating of the first computing unit 122, the first characteristic 111 may be stably controlled by the second computing unit 126 performing control using the relationship information.

Wobbles in control using the relationship information by the second computing unit 126 may be suppressed by waiting until control by the second computing unit 126 is stabilized after the stop of control by the first computing unit 122 and then causing the second computing unit 126 to start control using the relationship information.

Note that if the second computing unit 126 is caused to perform control using the relationship information even during control by the first computing unit 122, steps S204 and S206 may be omitted. If the response speed of control without the relationship information by the second computing unit 126 is sufficiently higher (e.g., ten or more times higher) than the response speed of feedback control by the first computing unit 122, the former control and the latter control do not interfere with each other. Accordingly, even without step S206, wobbles in control using the relationship information by the second computing unit 126 may be suppressed.

### (Example of Control State)

An example of the control state of the first characteristic 111 in a case where the second computing unit 126 performs control using the relationship information when the first computing unit 122 is in operation and performs control without the relationship information when the first computing unit 122 is not in operation will now be described.

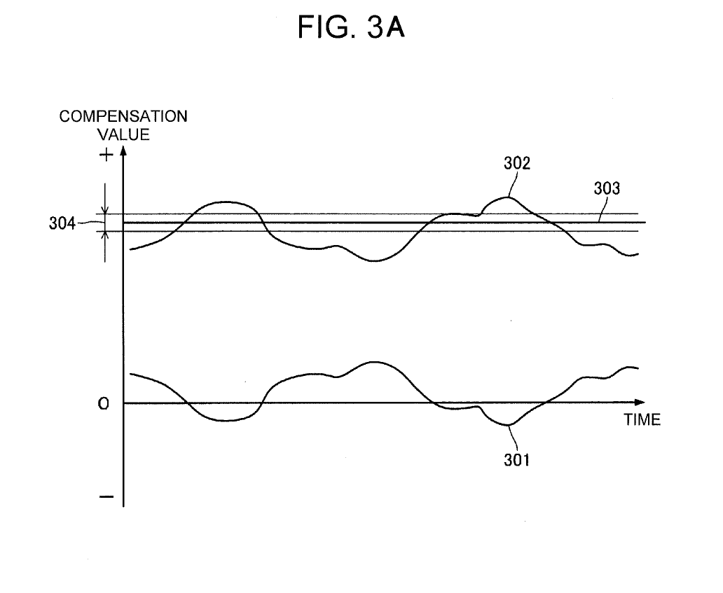

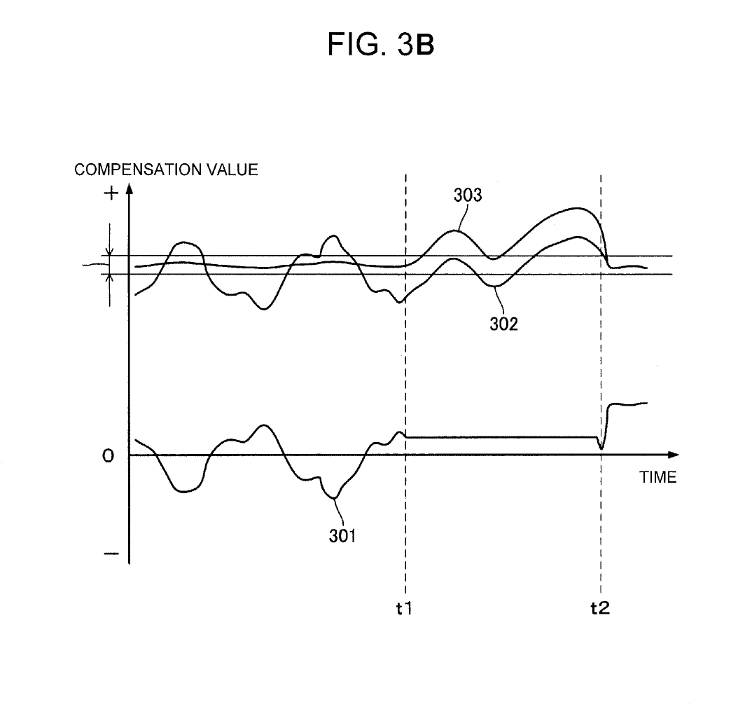

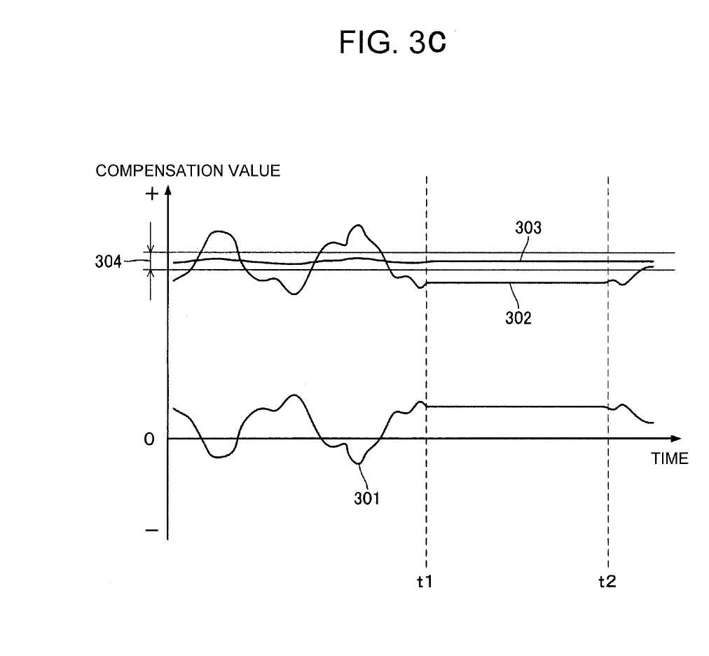

FIG. 3A is a chart depicting an example of the control state when the first computing unit is in operation. Referring to FIG. 3A, the abscissa represents time while the ordinate represents a compensation value for the first characteristic 111. A graph 301 of change in compensation value indicates a change in compensation value caused by feedback control by the first computing unit 122. A graph 302 of change in compensation value indicates a change in compensation value caused by control performed without the relationship information by the second computing unit 126. A graph 303 of change in compensation value indicates a change in an actual compensation value for the first characteristic 111, i.e., a change in a compensation value obtained by adding a value of the graph 301 of change in compensation value and a value of the graph 302 of change in compensation value.

An allowable range 304 is a range of a compensation value for the first characteristic 111 which is allowed in the processing device 110. Since control without the relationship information by the second computing unit 126 has low accuracy, the graph 302 of change in compensation value falls outside the allowable range 304. In contrast, since the accuracy of the first computing unit 122 is high, the graph 301 of change in compensation value fluctuates so as to compensate for the graph 302 of change in compensation value. For this reason, the actual compensation value falls within the allowable range 304, as indicated by the graph 303 of change in compensation value.

FIG. 3B is a reference chart depicting an example of the control state in a case where control by the second computing unit is not changed when the first computing unit is not in operation. Referring to FIG. 3B, a description of the same parts as those in FIG. 3A will be omitted. Assume a case where, during a period from a time point t1 to a time point t2, the function of the first computing unit 122 is updated, and feedback control by the first computing unit 122 is kept in abeyance, as indicated by the graph 301 of change in compensation value.

Also, assume that control by the second computing unit 126 is not changed to control using the relationship information during the period from the time point t1 to the time point t2. In this case, as indicated by the graph 303 of change in compensation value in FIG. 3B, as control by the second computing unit 126 proceeds, the graph 303 of change in compensation value departs away from the allowable range 304 due to, e.g., a disturbance.

FIG. 3C is a chart depicting an example of the control state in a case where control by the second computing unit is changed when the first computing unit is not in operation. Referring to FIG. 3C, a description of the same parts as those in FIG. 3B will be omitted. The updating control circuit 123 changes control by the second computing unit 126 to control using the relationship information during a period from the time point t1 to the time point t2.

Feedforward control by the second computing unit 126 after the switching is control that uses, as a reference value, a value detected at the time point t1 when the first computing unit is stopped and keeps a detected value at the reference value. With this control, as indicated by the graph 303 of change in compensation value, an actual compensation value falls within the allowable range 304. The updating control circuit 123 restarts feedback control by the first computing unit 122 at the time point t2 and returns control by the second computing unit 126 to the original condition.

### (Modification of Updating Control)

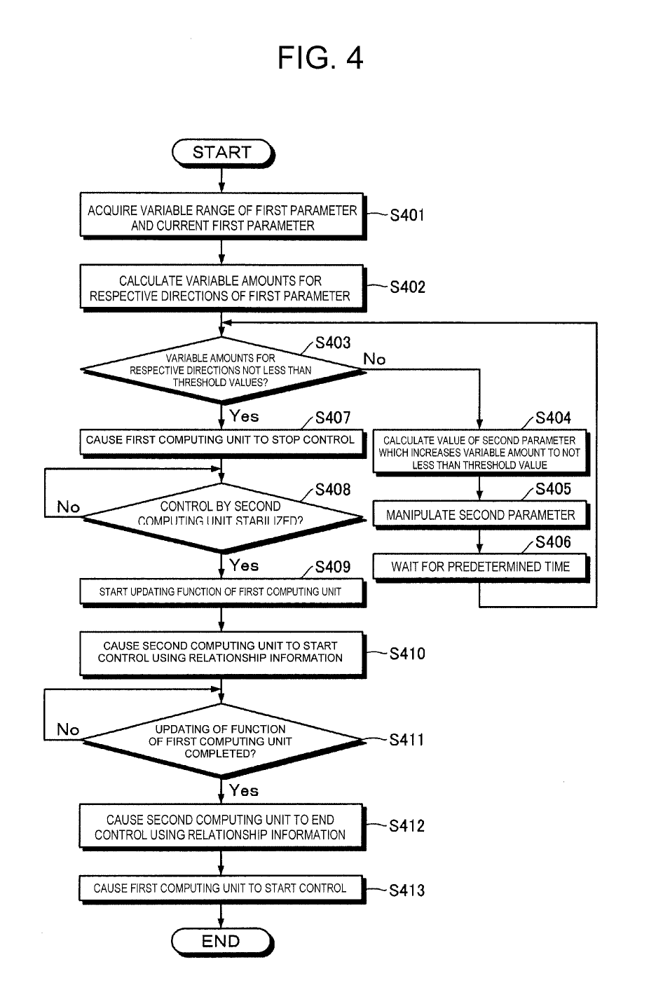

FIG. 4 is a flow chart depicting a modification of updating control by the updating control circuit. The updating control circuit 123 executes, for example, the steps depicted in FIG. 4 when updating the function of the first computing unit 122. Assume here that the second computing unit 126 performs control using the relationship information when the first computing unit 122 is not in operation and does not perform control using the relationship information when the first computing unit 122 is in operation. Also, assume that the parameter 113 includes a first parameter and a second parameter.

First, the updating control circuit 123 acquires the variable range of the first parameter and a current first parameter (step S401). For example, the variable range of the first parameter is stored in advance in the memory of the control device 120, and the updating control circuit 123 acquires the variable range of the first parameter from the memory. The updating control circuit 123 acquires the current first parameter by acquiring the first parameter output to the processing device 110.

The updating control circuit 123 calculates variable amounts for respective directions (an increasing direction and a decreasing direction) of the current first parameter (amounts by which the current first parameter may be varied in the respective directions) (step S402) on the basis of the variable range of the first parameter and the current first parameter acquired in step S401. The updating control circuit 123 may calculate the variable amount for the increasing direction of the current first parameter by, for example, calculating the difference between the upper limit for the first parameter and the current first parameter. The updating control circuit 123 may also calculate the variable amount for the decreasing direction of the current first parameter by calculating the difference between the lower limit for the first parameter and the current first parameter.

The updating control circuit 123 determines (step S403) whether the variable amounts for the respective directions calculated in step S402 are not less than corresponding threshold values. If at least one of the variable amounts for the respective directions is less than the threshold value (No in step S403), the updating control circuit 123 calculates a value of the second parameter which increases the variable amount for the direction less than the threshold value to not less than the threshold value (step S404). The updating control circuit 123 then manipulates the second parameter of the processing device 110 (step S405) such that the second parameter has the value calculated in step S404.

The updating control circuit 123 waits for a predetermined time (step S406) and returns to step S403. The predetermined time, for which the updating control circuit 123 waits in step S406, is set to, e.g., a time sufficient for a change in the first parameter caused by manipulation of the second parameter to converge.

If it is determined in step S403 that the variable amounts for the respective directions calculated in step S402 are not less than the threshold values (Yes in step S403), the updating control circuit 123 shifts to step S407. Steps S407 to S413 depicted in FIG. 4 are the same as steps S201 to S207 depicted in FIG. 2.

With the above-described steps, the first computing unit 122 may be stopped after the first parameter and the second parameter are adjusted on the basis of a value of the first parameter when the first computing unit 122 is to be stopped and the variable range of the first parameter. More specifically, the first parameter and the second parameter are adjusted such that the variable amounts for the increasing direction and the decreasing direction of the first parameter to be manipulated by the second computing unit 126 are not less than the threshold values.

The first parameter and the second parameter are both parameters which change the first characteristic 111, and the first parameter may be changed by adjusting the second parameter. For this reason, the variable amounts for the increasing direction and the decreasing direction of the first parameter in control by the second computing unit 126 are maintained, and the first characteristic 111 may be stably controlled.

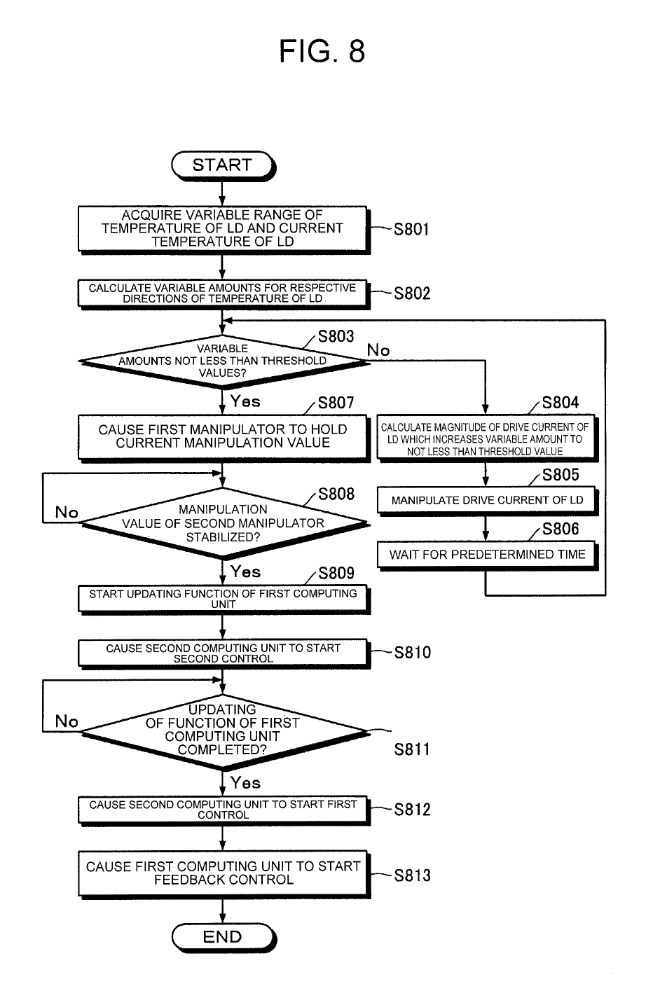

A case where the second characteristic 112 includes a third characteristic and a fourth characteristic, the first parameter is a parameter which changes the third characteristic, and the second parameter is a parameter including the fourth characteristic. In this case, the first parameter and the second parameter may be adjusted on the basis of a result of detecting the second characteristic 112 when the first computing unit 122 is to be stopped and the variable range of the second characteristic 112 (see, e.g., FIG. 8).

The first parameter and the second parameter are both parameters which change the first characteristic 111, and the first parameter may be changed by adjusting the second parameter. For this reason, the variable amounts for the increasing direction and the decreasing direction of the second characteristic 112 in control by the second computing unit 126 are maintained, and the first characteristic 111 may be stably controlled.

As described above, the control device 120 according to the first embodiment uses relationship information between a detected value and a manipulation value in feedforward control to be performed by the second computing unit 126 during updating of the function of the first computing unit 122 that performs feedback control. Since the use of the relationship information allows derivation of an amount to be manipulated which may cancel the amount of change in the detected value, the accuracy of feedforward control may be improved (a systematic error may be reduced). Accordingly, control of the first characteristic 111 during updating of the first computing unit 122 may be stabilized.

The result of detecting the second characteristic 112 when control of the parameter 113 by the first computing unit 122 is to be stopped may be used as a reference value, and an amount to be manipulated for the parameter 113 which compensates for a change from the reference value as the result of detecting the second characteristic 112 may be derived. This makes it possible to keep the second characteristic 112 during suspension of control by the first computing unit 122 in a state when control by the first computing unit 122 is stopped. Accordingly, fluctuations in the first characteristic 111 may be suppressed during suspension of control by the first computing unit 122.

If the first parameter is adjusted in advance before control by the first computing unit 122 is stopped, feedforward control by the second computing unit 126 may be performed while the variable amounts for the increasing direction and the decreasing direction of the first parameter are maintained. Accordingly, the first characteristic 111 may be more stably controlled.

The updating control circuit 123 switches control by the second computing unit 126 at the time of updating of the first computing unit 122. This inhibits control by the first computing unit 122 and control by the second computing unit 126 from interfering with each other and allows stabilization of control of the first characteristic 111.

### Second Embodiment

### Configuration Example of Optical Receiving Device

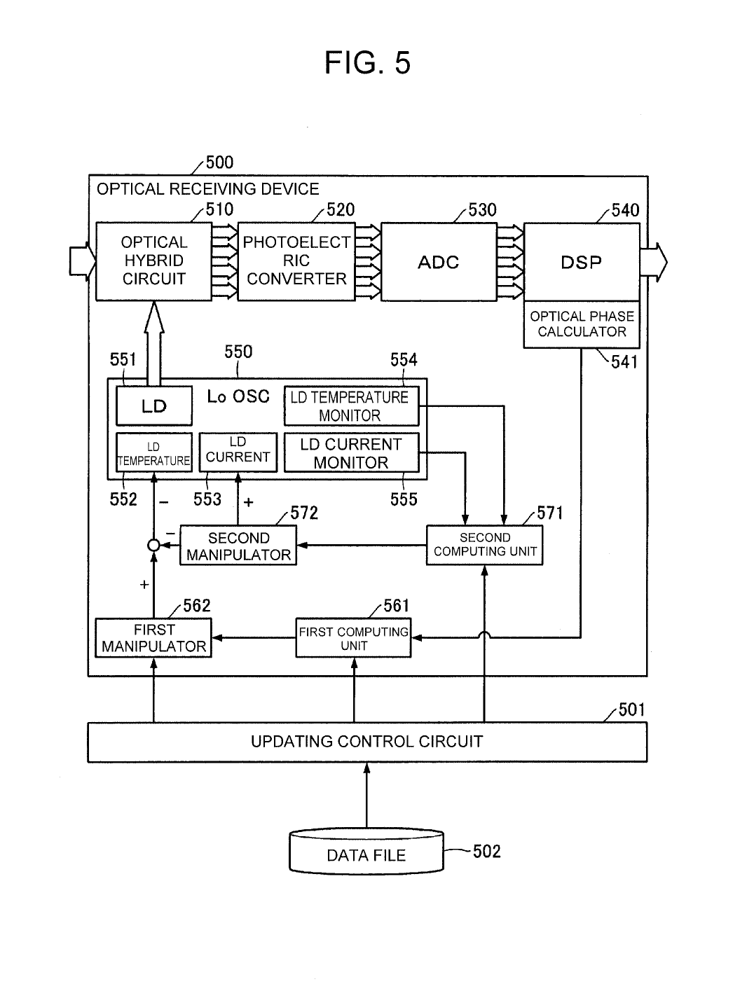

FIG. 5 is a diagram depicting a configuration example of an optical receiving device according to a second embodiment. An optical receiving device 500 depicted in FIG. 5 is an optical receiving device to which the control device 120 depicted in FIG. 1 is applied. The optical receiving device 500 is a coherent optical receiving device which receives signal light by intradyne detection. The optical receiving device 500 includes an optical hybrid circuit 510, a photoelectric converter 520, an ADC 530, a DSP 540, a local oscillator 550, a first computing unit 561, a first manipulator 562, a second computing unit 571, and a second manipulator 572.

### <Concerning Optical Receiving Circuit>

The optical hybrid circuit 510, photoelectric converter 520, ADC 530, DSP 540, and local oscillator 550 are components corresponding to the processing device 110 depicted in FIG. 1 and are optical receiving circuits which receive signal light by intradyne detection.

The optical hybrid circuit 510 causes signal light input to the optical receiving device 500 and local oscillation light output from the local oscillator 550 to interfere with each other at a plurality of different phases (mixes the signal light and the local oscillation light). The optical hybrid circuit 510 is, for example, a 90° hybrid circuit which causes signal light and local oscillation light at phases of 0° and 90°. The optical hybrid circuit 510 outputs each beat signal beam (an interference result) obtained by interference to the photoelectric converter 520. Each beat signal beam is a signal indicating the amplitude and phase of signal light input to the optical receiving device 500.

The photoelectric converter 520 photoelectrically converts each beat signal beam output from the optical hybrid circuit 510 and outputs a beat signal obtained by the photoelectric conversion to the ADC 530. The ADC (Analog/Digital Converter) 530 converts each beat signal output from the photoelectric converter 520 to a digital signal. The ADC 530 outputs each beat signal as a digital signal to the DSP 540.

The DSP (Digital Signal Processor) 540 demodulates each beat signal output from the ADC 530 by digitally processing the beat signal and identifies data indicated by signal light input to the optical receiving device 500. The DSP 540 includes an optical phase calculator 541. The optical phase calculator 541 calculates (estimates) the phase difference (phase shift) between local oscillation light output from the local oscillator 550 and signal light input to the optical receiving device 500 by digital processing of each beat signal output from the ADC 530.

The optical phase calculator 541 is a component corresponding to the first detection section 121 depicted in FIG. 1. The phase difference between local oscillation light and signal light is a characteristic to be compensated for corresponding to the first characteristic 111 depicted in FIG. 1. The phase difference between local oscillation light and signal light is caused by the difference between the frequency of local oscillation light output from the local oscillator 550 and the carrier center frequency of signal light. The carrier center frequency of signal light depends on the oscillation frequency of a light source on the transmitting side. The optical phase calculator 541 outputs a calculated phase difference value indicating a calculated phase difference to the first computing unit 561.

### <Concerning Local Oscillator>

The local oscillator 550 (Lo OSC) includes an LD 551, an LD temperature adjusting section 552, an LD current adjusting section 553, an LD temperature monitor 554, and an LD current monitor 555. The LD temperature monitor 554 and LD current monitor 555 are components corresponding to the second detection section 124 depicted in FIG. 1.

The LD (Laser Diode) 551 generates local oscillation light and outputs the local oscillation light to the optical hybrid circuit 510. The local oscillation light to be generated by the LD 551 is, for example, CW (Continuous Wave) light. The temperature of the LD 551 and the magnitude of drive current supplied to the LD 551 are characteristics corresponding to the second characteristic 112 described with reference to FIG. 1. For example, the temperature of the LD 551 corresponds to the third characteristic, and the magnitude of the drive current supplied to the LD 551 corresponds to the fourth characteristic.

The LD 551 is, for example, a DFB (Distributed Feedback) laser. Alternatively, the LD 551 may be a DBR (Distributed Bragg Reflector) laser or the like. The frequency of local oscillation light generated by the LD 551 depends on the temperature of the LD 551 and the magnitude of drive current which drives the LD 551 (see, e.g., Japanese Laid-Open Patent Publication No. 8-316576).

The LD temperature adjusting section 552 adjusts the temperature of the LD 551 according to an input value for manipulating temperature. The LD temperature adjusting section 552 is, for example, a heating element, such as a heater, or an element capable of heating and cooling, such as a Peltier element.

The LD current adjusting section 553 adjusts the magnitude of drive current supplied to the LD 551 according to an input manipulation value. For example, drive current is input as the manipulation value to the LD current adjusting section 553. In this case, the LD current adjusting section 553 supplies the input drive current to the LD 551. Alternatively, a control signal indicating the magnitude of drive current may be input as the manipulation value to the LD current adjusting section 553. In this case, the LD current adjusting section 553 adjusts drive current to be supplied from a power supply to the LD 551 on the basis of the input control signal.

The LD temperature monitor 554 monitors the temperature of the LD 551. The LD temperature monitor 554 outputs a monitored temperature value indicating a result of monitoring the temperature to the second computing unit 571. The LD current monitor 555 monitors the magnitude of drive current to the LD 551. The LD current monitor 555 outputs a monitored current value indicating a result of monitoring the magnitude of drive current to the second computing unit 571.

### <Concerning First Computing Unit and First Manipulator>

The first computing unit 561 and first manipulator 562 are components corresponding to the first computing unit 122 depicted in FIG. 1. The first computing unit 561 controls the frequency of local oscillation light output from the local oscillator 550 on the basis of the calculated phase difference value output from the optical phase calculator 541 to perform feedback control that compensates for the phase difference between the local oscillation light and signal light.

More specifically, the first computing unit 561 controls the frequency of the local oscillation light such that a phase difference indicated by the calculated phase difference value falls within a predetermined range. The first computing unit 561 controls the frequency of the local oscillation light by controlling the temperature of the LD 551. The first computing unit 561 controls the temperature of the LD 551 by controlling the value for manipulating temperature which the first manipulator 562 outputs to the local oscillator 550.

For example, if the frequency of the local oscillation light is higher than the frequency of the signal light, the first computing unit 561 controls the temperature of the LD 551 so as to decrease by a certain amount, on the basis of the calculated phase difference value. On the other hand, if the frequency of the local oscillation light is higher than the frequency of the signal light, the first computing unit 561 controls the temperature of the LD 551 so as to increase by a certain amount. Feedback control by the first computing unit 561 is performed with, e.g., an accuracy which may compensate for a difference in frequency of about 100 [MHz] or less between signal light and local oscillation light.

The first computing unit 561 is a programmable device whose function may be externally updated, such as a PLD, an FPGA, or a CPU. More specifically, the first computing unit 561 may update its function under control of an updating control circuit 501.

The first manipulator 562 manipulates the temperature of the LD 551 by outputting the value for manipulating temperature to the LD temperature adjusting section 552 under control of the first computing unit 561. For example, the first computing unit 561 outputs the value for manipulating temperature as a digital signal to the first manipulator 562. The first manipulator 562 converts the value for manipulating temperature output from the first computing unit 561 to an analog signal and outputs the value for manipulating temperature to the LD temperature adjusting section 552. The first manipulator 562 may also fix the value for manipulating temperature to be output to the LD temperature adjusting section 552 under control of the updating control circuit 501. The value for manipulating temperature is a parameter corresponding to the first parameter of the parameter 113 described with reference to FIG. 1.

### <Concerning Second Computing Unit and Second Manipulator>

The second computing unit 571 and second manipulator 572 are components corresponding to the second computing unit 126 depicted in FIG. 1. The second computing unit 571 controls the frequency of local oscillation light output from the local oscillator 550 on the basis of a monitored value output from the local oscillator 550 to perform feedforward control that compensates for the phase difference between the local oscillation light and signal light. The monitored value output from the local oscillator 550 is, for example, at least one of temperature information and current information.

More specifically, the second computing unit 571 controls the frequency of the local oscillation light by controlling at least one of the temperature of the LD 551 and drive current. The second computing unit 571 controls the temperature of the LD 551 by controlling the value for manipulating temperature which the second manipulator 572 outputs to the local oscillator 550. The second computing unit 571 controls drive current to the LD 551 by controlling the value for manipulating current which the second manipulator 572 outputs to the local oscillator 550.

The second computing unit 571 may perform control of the frequency of the local oscillation light based on the monitored value while switching between first control and second control with different accuracies. For example, the second computing unit 571 has the function of performing the first control and the second control and switches between the first control and the second control in accordance with a control signal from the updating control circuit 501. Alternatively, the second computing unit 571 may be a circuit whose function may be updated (rewritten) by the updating control circuit 501 and may switch between the first control and the second control through updating by the updating control circuit 501.

In the first control, the second computing unit 571 controls the second manipulator 572 to change a manipulation value (at least one of the value for manipulating temperature and the value for manipulating current) when the monitored value falls outside a predetermined range. In the first control, feedforward control by the second computing unit 571 is performed with, e.g., an accuracy lower than an accuracy which may compensate for a difference in frequency of about 100 [MHz] or less between the signal light and the local oscillation light.

In the second control, the second computing unit 571 derives an amount of change for the manipulation value (at least one of the value for manipulating temperature and the value for manipulating current) based on the amount of change in the monitored value and controls the second manipulator 572 to change the manipulation value by the derived amount of change. More specifically, relationship information indicating the relationship (e.g., the ratio) between the monitored value and the manipulation value is stored in the second computing unit 571. The second computing unit 571 derives an amount of change for the manipulation value which compensates for the amount of change in the monitored value output from the local oscillator 550 on the basis of the relationship information and controls the second manipulator 572 according to the derived amount of change for the manipulation value.

The relationship information may be information indirectly indicating the relationship between the monitored value and the manipulation value, such as a combination of first relationship information indicating the relationship between the monitored value and the frequency of local oscillation light and second relationship information associating the frequency of local oscillation light with the manipulation value. Alternatively, the relationship information may be, for example, relationship information which directly associates the monitored value with the manipulation value.

As described above, the second control may compensate for the phase difference between local oscillation light and signal light with higher accuracy than the first control by using the relationship information. The second computing unit 571 may be implemented by, for example, a programmable device whose function may be externally updated, such as a PLD, an FPGA, or a CPU.

The second manipulator 572 manipulates the temperature of the LD 551 of the local oscillator 550 by outputting the value for manipulating temperature to the LD temperature adjusting section 552 under control of the second computing unit 571. The second manipulator 572 also manipulates the drive current to the LD 551 by inputting the value for manipulating current to the LD current adjusting section 553 under control of the second computing unit 571.

For example, the second computing unit 571 outputs the value for manipulating temperature as a digital signal to the second manipulator 572. The second manipulator 572 converts the value for manipulating temperature output from the second computing unit 571 to an analog signal and outputs the value for manipulating temperature to the LD temperature adjusting section 552. For example, the second computing unit 571 also outputs the value for manipulating current as a digital signal to the second manipulator 572. The second manipulator 572 converts the value for manipulating current output from the second computing unit 571 to an analog signal and outputs the value for manipulating current to the LD current adjusting section 553. The value for manipulating current is a parameter corresponding to the second parameter of the parameter 113 described with reference to FIG. 1.

### <Concerning Updating Control Circuit>

The updating control circuit 501 is a component corresponding to the updating control circuit 123 depicted in FIG. 1. The updating control circuit 501 updates the function of the first computing unit 561. For example, the updating control circuit 501 downloads a data file 502 over a network and updates the function of the first computing unit 561 on the basis of the downloaded data file 502. The updating control circuit 501 stops feedback control by the first computing unit 561 when updating the function of the first computing unit 561.

The updating control circuit 501 controls the first manipulator 562 to hold the value for manipulating temperature to be output while feedback control by the first computing unit 561 is stopped. The updating control circuit 501 also sets control by the second computing unit 571 to the first control during execution of feedback control by the first computing unit 561 and to the second control during suspension of feedback control by the first computing unit 561. The updating control circuit 501 may be implemented by, for example, a programmable device whose function may be externally updated, such as a PLD, an FPGA, or a CPU.

### (Characteristic of LD)

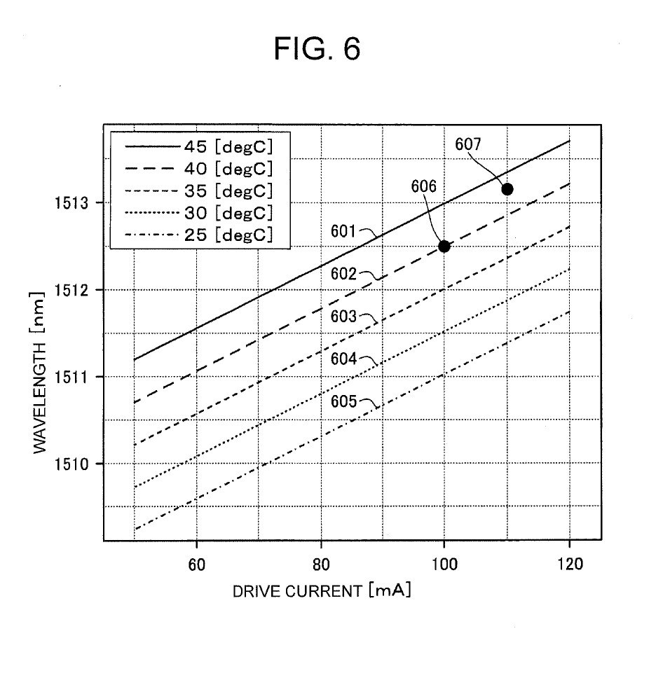

FIG. 6 is a chart depicting examples of a characteristic of an LD. Referring to FIG. 6, a characteristic of the LD 551 when a DFB laser is used will be described as an example. The abscissa in FIG. 6 represents the magnitude [mA] of drive current supplied to the LD 551 while the ordinate represents the wavelength [nm] of local oscillation light output from the LD 551. Characteristics 601 to 605 are characteristics, respectively, of the wavelength of local oscillation light versus drive current when the temperature of the LD 551 are 45, 40, 35, 30, and 25 [degC.].

As indicated by the characteristics 601 to 605, the wavelength of local oscillation light output from the LD 551 increases with an increase in the magnitude of drive current. The frequency of the local oscillation light output from the LD 551 thus decreases with an increase in the magnitude of drive current. Also, the wavelength of the local oscillation light output from the LD 551 increases with an increase in the temperature of the LD 551. The frequency of the local oscillation light output from the LD 551 thus decreases with an increase in the temperature of the LD 551.

For example, if a target value for the wavelength of the local oscillation light output from the LD 551 is set to 1512.5 [nm], the temperature of the LD 551 may be set to 40 [degC.], and the magnitude of the drive current may be set to 100 [mA], as indicated by a coordinate point 606. For example, if a disturbance or the like increases the temperature of the LD 551 to 43 [degC.] and the magnitude of the drive current to 110 [mA], the wavelength of the local oscillation light increases to about 1513.2 [nm], as indicated by a coordinate point 607.

### (Specific Example of Second Control by Second Computing Unit)

An example of the second control by the second computing unit 571 will be described. Assume here that the value for manipulating temperature output from the first manipulator 562 converges on +1 [degC.] by feedback control by the first computing unit 561 at the time of normal operation of the optical receiving device 500.

The target value for the wavelength of local oscillation light output from the LD 551 is set to 1512.5 [nm]. In this case, the manipulation values are controlled by feedforward control by the second computing unit 571 such that the temperature of the LD 551 is 40 [degC.] and such that the magnitude of the drive current is 100 [mA] (see the coordinate point 606 in FIG. 6). Assume here a case where the monitored temperature value indicating that the temperature of the LD 551 is 43 [degC.] and the monitored current value indicating that the magnitude of the drive current is 110 [mA] are input to the second computing unit 571 (see the coordinate point 607 in FIG. 6).

If the values to be achieved by feedforward control by the second computing unit 571 and the manipulation values in feedback control by the first computing unit 561 are simply added, an LD temperature of 41 (=40+1) [degC.] and an LD current of 100 [mA] are obtained. Note that since an absolute value here lacks accuracy, a deviation of +2 [degC.] and a deviation of +10 [mA] are occurring.

A function representing the relationship between the temperature of the LD 551 and the frequency of local oscillation light and a function representing the relationship between drive current to the LD 551 and the frequency of local oscillation light are stored in advance in the second computing unit 571. For example, assume that the ratio of the wavelength of local oscillation light to the temperature of the LD 551 is 0.5 [nm]/5 [degC.]=0.1 [nm/degC.], as depicted in FIG. 6. Assuming that a change in optical wavelength with respect to a change in optical frequency of Δ100 [GHz] is −Δ0.8 [nm], the ratio of the frequency of local oscillation light to the temperature of the LD 551 is −12.5 [GHz/degC.].

Also, assume that the ratio of the wavelength of local oscillation light to the drive current to the LD 551 is 1.5 [nm]/40 [mA]=0.035 [nm/mA], as depicted in FIG. 6. Assuming that a change in optical wavelength with respect to a change in optical frequency of Δ100 [GHz] is −Δ0.8 [nm], the ratio of the frequency of local oscillation light to the drive current to the LD 551 is −4.375 [GHz/mA].

For example, in order to perform control with an optical frequency resolution of 100 [MHz], the LD temperature monitor 554 and the second manipulator 572 are adapted to have resolutions of at least 80 [mdegC.]. The LD current monitor 555 and the second manipulator 572 are adapted to have resolutions of at least 23 [μA].

In the second control by the second computing unit 571 when the first computing unit 561 is not in operation, a reference temperature value for the LD 551 is set to the monitored temperature value when feedback control by the first computing unit 561 is stopped. In the second control by the second computing unit 571 when the first computing unit 561 is not in operation, a reference current value is set to the monitored current value when feedback control by the first computing unit 561 is stopped. The second computing unit 571 periodically calculates the amount of change of the current frequency of local oscillation light from the frequency of local oscillation light when feedback control by the first computing unit 561 is stopped.

For example, the second computing unit 571 may calculate the amount of change in the frequency of local oscillation light with respect to a change in the temperature of the LD 551 according to, e.g., Expression (1) below. The second computing unit 571 may also calculate the amount of change in the frequency of local oscillation light with respect to a change in the drive current to the LD 551 according to, e.g., Expression (2) below.

((Current Monitored Temperature Value)−(Reference Temperature Value))*(−12.5) (1)

((Current Monitored Current Value)−(Reference Current Value))*(−4.375) (2)

The second computing unit 571 may calculate a change (deviation) of the current frequency of local oscillation light from the frequency of local oscillation light when feedback control by the first computing unit 561 is stopped by adding results of calculating Expressions (1) and (2) above. The second computing unit 571 calculates an amount of change for at least one of the value for manipulating temperature and the value for manipulating current for compensating for the calculated amount of change in frequency and controls the second manipulator 572 on the basis of the calculated amount of change.

For example, a piece of relationship information indicating the relationship (e.g., the ratio) between the value for manipulating temperature to be input to the LD temperature adjusting section 552 and the temperature of the LD 551 is stored in the second computing unit 571. A piece of relationship information indicating the relationship (e.g., the ratio) between the value for manipulating current to be input to the LD current adjusting section 553 and the drive current to the LD 551 is also stored in the second computing unit 571.

The second computing unit 571 may calculate an amount of change for at least one of the value for manipulating temperature and the value for manipulating current for compensating for a change in frequency on the basis of the stored pieces of relationship information. For this reason, the frequency of local oscillation light may be kept with high accuracy at a frequency when feedback control by the first computing unit 561 is stopped.

### (Updating Control by Updating Control Circuit)

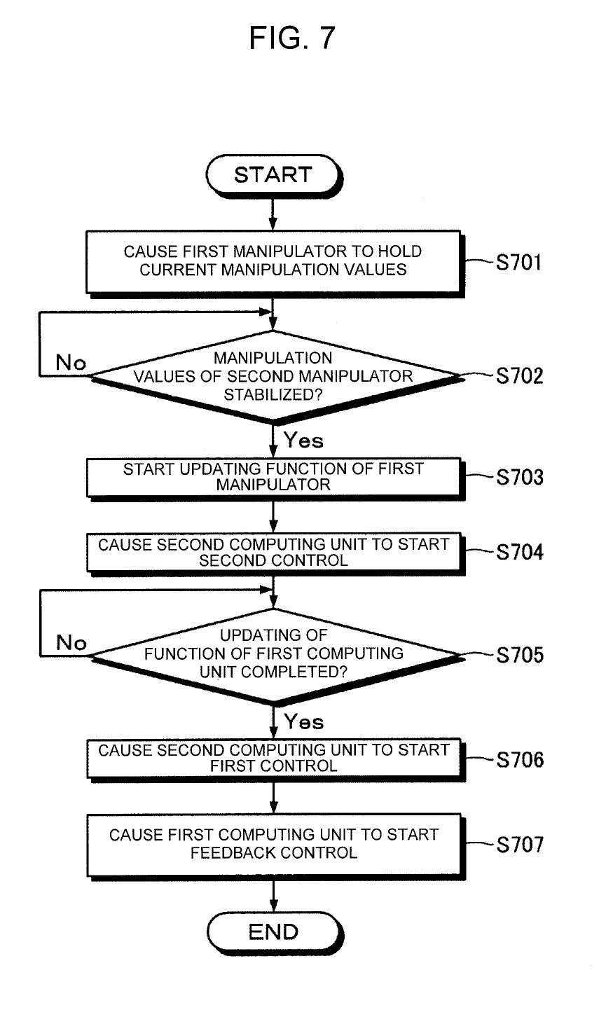

FIG. 7 is a flow chart depicting a first example of updating control by the updating control circuit. The updating control circuit 501 executes, for example, the steps depicted in FIG. 7 when updating the function of the first computing unit 561. Assume that the second computing unit 571 is performing the first control in an initial state. First, the updating control circuit 501 causes the first manipulator 562 to hold the current manipulation values (step S701). The updating control circuit 501 determines (step S702) whether the manipulation values (the value for manipulating temperature and the value for manipulating current) output from the second manipulator 572 has been stabilized.

For example, the updating control circuit 501 acquires the manipulation values output from the second manipulator 572 at fixed time intervals and calculates the amounts of change in the acquired manipulation values. The updating control circuit 501 determines that the manipulation values have not been stabilized if the calculated amounts of change are higher than corresponding threshold values and determines that the manipulation values have been stabilized if the calculated amounts of change are not more than the threshold values.

In step S702, the updating control circuit 501 waits (No loop in step S702) until the manipulation values are stabilized. When the manipulation values have been stabilized (Yes in step S702), the updating control circuit 501 starts updating the function of the first computing unit 561 (step S703). The updating control circuit 501 then causes the second computing unit 571 to start the second control (step S704). The second computing unit 571 starts high-accuracy feedforward control using the pieces of relationship information.

The updating control circuit 501 determines (step S705) whether the updating of the function of the first computing unit 561 that is started in step S703 is completed and waits (No loop in step S705) until the updating of the function of the first computing unit 561 is completed. When the updating of the function of the first computing unit 561 is completed (Yes in step S705), the updating control circuit 501 causes the second computing unit 571 to start the first control (step S706). Feedforward control by the second computing unit 571 returns to the first control for normal time.

The updating control circuit 501 causes the first computing unit 561 to start feedback control (step S707) and ends the series of control operations. The above-described steps make it possible to update the function of the first computing unit 561 while receiving light by the optical receiving device 500. During updating of the first computing unit 561, compensation for a phase difference may be stably performed by causing the second computing unit 571 to perform high-accuracy feedforward control, even if feedback control by the first computing unit 561 is stopped.

FIG. 8 is a flow chart depicting a second example of updating control by the updating control circuit. The updating control circuit 501 may execute, for example, the steps depicted in FIG. 8 when updating the function of the first computing unit 561. First, the updating control circuit 501 acquires the variable range of the temperature of the LD 551 and the current temperature of the LD 551 (step S801). For example, the variable range of the temperature of the LD 551 is stored in advance in a memory of the optical receiving device 500, and the updating control circuit 501 acquires the variable range of the temperature of the LD 551 from the memory. The updating control circuit 501 acquires the current temperature by acquiring the monitored temperature value output from the LD temperature monitor 554.

The updating control circuit 501 then calculates variable amounts for respective directions (an increasing direction and a decreasing direction) of the temperature of the LD 551 (step S802) on the basis of the variable range of the temperature and the current temperature acquired in step S801. The updating control circuit 501 may calculate the variable amount for the increasing direction of the current temperature of the LD 551 by, for example, calculating the difference between the upper limit for the temperature of the LD 551 and the current temperature of the LD 551. The updating control circuit 501 may also calculate the variable amount for the decreasing direction of the current temperature of the LD 551 by, for example, calculating the difference between the lower limit for the temperature of the LD 551 and the current temperature of the LD 551. The updating control circuit 501 determines (step S803) whether the variable amounts for the respective directions calculated in step S802 are not less than corresponding threshold values.

If it is determined in step S803 that at least one of the variable amounts for the respective directions is less than the threshold value (No in step S803), the updating control circuit 501 calculates a magnitude of the drive current to the LD 551 which increases the variable amount for the direction less than the threshold value to not less than the threshold value (step S804). The updating control circuit 501 then controls the second manipulator 572 to manipulate the drive current to the LD 551 (step S805) such that the drive current has the magnitude calculated in step S804.

The updating control circuit 501 waits for a predetermined time (step S806) and returns to step S803. The predetermined time, for which the updating control circuit 501 waits in step S806, is set to, e.g., a time sufficient for a change in the temperature of the LD 551 caused by manipulation of the drive current to the LD 551 to converge.

If it is determined in step S803 that the variable amounts for the respective directions calculated in step S802 are not less than the threshold values (Yes in step S803), the updating control circuit 501 shifts to step S807. Steps S807 to S813 depicted in FIG. 8 are the same as steps S701 to S707 depicted in FIG. 7.

With the above-described steps, the first computing unit 561 may be stopped after the temperature of the LD 551 and the magnitude of the drive current are adjusted on the basis of a result of detecting the temperature of the LD 551 when the first computing unit 561 is to be stopped and the variable range of the temperature of the LD 551. More specifically, the temperature of the LD 551 and the magnitude of the drive current are adjusted such that the variable amounts for the increasing direction and the decreasing direction of the temperature of the LD 551 are not less than the threshold values.

The temperature of the LD 551 and the magnitude of the drive current are both parameters which change the frequency of local oscillation light, and the temperature of the LD 551 may be changed by adjusting the magnitude of the drive current. For this reason, the variable amounts for the increasing direction and the decreasing direction of the temperature of the LD 551 in control by the second computing unit 571 are maintained, and the phase difference between local oscillation light and signal light may be stably controlled.

### (Specific Example of Adjustment of Magnitude of Drive Current)

For example, as described above, assume that the temperature of the LD 551 is set to 40 [degC.] and the magnitude of the drive current is set to 100 [mA], according to the manipulation values from the second computing unit 571. The variable range of the temperature of the LD 551 under control of the second computing unit 571 is 36 to 40.5 [degC.]. The variable range of the magnitude of the drive current to the LD 551 is 90 to 105 [mA].

In this case, the second computing unit 571 may change the currently set temperature of the LD 551 within the range of Δ−4 to Δ+0.5 [degC.]. The second computing unit 571 may also change the currently set magnitude of the drive current to the LD 551 within the range of Δ−10 to Δ+5 [mA]. Accordingly, the variable amount for the increasing direction of the temperature of the LD 551 is as small as Δ+0.5 [degC.].

The temperature of the LD 551 in this state is decreased by 2 [degC.] to be 38 [degC.] by, for example, manipulating the drive current to the LD 551, and the second control by the second computing unit 571 is performed. This allows the second computing unit 571 to change the currently set temperature of the LD 551 within the range of Δ−2 to Δ+2.5 [degC.] in the second control. Accordingly, even if the temperature decreases by 2.5 [degC.] due to a disturbance, the second computing unit 571 may increase the temperature of the LD 551 by 2.5 [degC.] and thus may keep the temperature of the LD 551 constant.

As described above, according to the optical receiving device 500 of the second embodiment, relationship information between a detected value and a manipulation value is used in feedforward control to be performed by the second computing unit 571 during updating of the function of the first computing unit 561 that performs feedback control. The use improves the accuracy of feedforward control and stabilizes control of the phase difference between local oscillation light and signal light even during updating of the first computing unit 561. Accordingly, communication quality may be improved.

For example, the local oscillator 550, second computing unit 571, and second manipulator 572 depicted in FIG. 5 are implemented by an ITLA (Integrable Tunable Laser Assembly) module. In contrast, the first computing unit 561 and first manipulator 562 are, for example, programmable devices which are provided separately from the ITLA module. The scale of the components is large.

In the optical receiving device 500, high-accuracy control to be performed during suspension of feedback control by the first computing unit 561 and first manipulator 562 is implemented by feedforward control by the second computing unit 571 and second manipulator 572. Accordingly, the circuit scale may be made smaller than, for example, a case where circuits for feedback control similar to the first computing unit 561 and first manipulator 562 are provided separately from the ITLA module.

### Third Embodiment

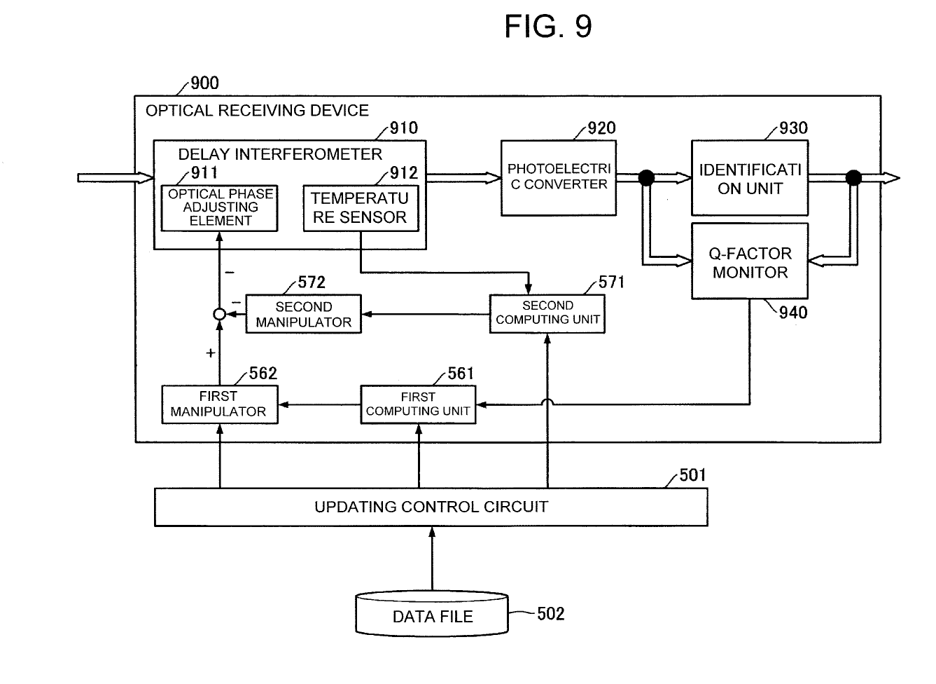

FIG. 9 is a diagram depicting a configuration example of an optical receiving device according to a third embodiment. Referring to FIG. 9, the same parts as those depicted in FIG. 5 are denoted by the same reference numerals, and a description thereof will be omitted. An optical receiving device 900 depicted in FIG. 9 is an optical receiving device to which the control device 120 depicted in FIG. 1 is applied. The optical receiving device 900 includes a delay interferometer 910, a photoelectric converter 920, an identification unit 930, a Q-factor monitor 940, a first computing unit 561, a first manipulator 562, a second computing unit 571, and a second manipulator 572.

### <Concerning Optical Receiving Circuit>

The delay interferometer 910, photoelectric converter 920, and identification unit 930 are components corresponding to the processing device 110 depicted in FIG. 1 and are optical receiving circuits which receive signal light modulated by, e.g., DQPSK (Differential Quadrature Phase Shift Keying).

The delay interferometer 910 branches signal light input to the optical receiving device 900 and provides a phase difference for, e.g., one symbol to the branch signal beams. The delay interferometer 910 causes the signal beams with the phase difference therebetween to interfere with each other and outputs the resultant signal light to the photoelectric converter 920. The delay interferometer 910 includes an optical phase adjusting element 911 and a temperature sensor 912.

The optical phase adjusting element 911 provides a phase difference to branch signal beams. For example, the optical phase adjusting element 911 provides a phase difference to the branch signal beams by adjusting the optical phase (the amount of delay) of one of the branch signal beams to an optical phase corresponding to an input value for manipulating phase. For example, the optical phase adjusting element 911 changes the optical phase of the one of the branch signal beams by changing the temperature of an optical waveguide through which the one of the branch signal beams passes.

The temperature sensor 912 detects the temperature (e.g., the case temperature) of the delay interferometer 910. The temperature sensor 912 outputs a detected temperature value indicating the detected temperature to the second computing unit 571. The temperature sensor 912 is a component corresponding to the second detection section 124 depicted in FIG. 1. The temperature of the delay interferometer 910 is a characteristic corresponding to the second characteristic 112 described with reference to FIG. 1.

The photoelectric converter 920 photoelectrically converts the signal light output from the delay interferometer 910 and outputs an electrical signal obtained by the conversion to the identification unit 930. The identification unit 930 identifies data indicated by the signal output from the photoelectric converter 920. The identification unit 930 outputs the identified data.

The Q-factor monitor 940 detects the Q-factor (reception quality) of the signal light received by the optical receiving device 900 on the basis of the signal output from the photoelectric converter 920 and the data output from the identification unit 930. The Q-factor monitor 940 is a characteristic corresponding to the first detection section 121 depicted in FIG. 1. The Q-factor is a characteristic to be compensated for corresponding to the first characteristic 111 depicted in FIG. 1 and indicates the reception quality of signal light received by the optical receiving device 900.

The Q-factor monitor 940 outputs the detected Q-factor to the first computing unit 561. The Q-factor detected by the Q-factor monitor 940 depends on the phase difference between branch signal beams obtained by the optical phase adjusting element 911. More specifically, the Q-factor detected by the Q-factor monitor 940 increases as the phase difference between branch signal beams obtained by the optical phase adjusting element 911 approaches a predetermined phase difference (e.g., a phase difference for one symbol).

### <Concerning First Computing Unit and First Manipulator>

The first computing unit 561 controls the phase difference between branch signal beams obtained by the delay interferometer 910 on the basis of the Q-factor output from the Q-factor monitor 940 and performs feedback control that increases the Q-factor. More specifically, the first computing unit 561 controls the optical phase of the optical phase adjusting element 911 such that the Q-factor falls within a predetermined range. The first computing unit 561 controls the optical phase of the optical phase adjusting element 911 by controlling the value for manipulating phase which the first manipulator 562 outputs to the optical phase adjusting element 911.

For example, the first computing unit 561 changes the optical phase of the optical phase adjusting element 911 in an appropriate direction and determines whether the Q-factor has been increased. The first computing unit 561 repeats control that changes the optical phase further in the same direction if the Q-factor has been increased and changes the optical phase in the opposite direction if the Q-factor has been decreased. Feedback control by the first computing unit 561 is performed with, e.g., an accuracy which may compensate for a difference in frequency of about 100 [MHz] or less between branch signal beams with a phase difference obtained by the delay interferometer 910.

The first manipulator 562 manipulates the optical phase of the optical phase adjusting element 911 by outputting the value for manipulating phase to the optical phase adjusting element 911 under control of the first computing unit 561. For example, the first computing unit 561 outputs the value for manipulating phase as a digital signal to the first manipulator 562. The first manipulator 562 converts the value for manipulating phase output from the first computing unit 561 to an analog signal and outputs the value for manipulating phase to the optical phase adjusting element 911. The first manipulator 562 may also fix the value for manipulating phase to be output to the optical phase adjusting element 911 under control of the updating control circuit 501. The value for manipulating phase is a parameter corresponding to the parameter 113 described with reference to FIG. 1.

### <Concerning Second Computing Unit and Second Manipulator>

The second computing unit 571 controls the phase difference between branch signal beams obtained by the delay interferometer 910 on the basis of the detected temperature value output from the temperature sensor 912 and performs feedforward control that increases the Q-factor. More specifically, the second computing unit 571 controls the optical phase of the optical phase adjusting element 911 such that the Q-factor falls within the predetermined range. The first computing unit 561 controls the optical phase of the optical phase adjusting element 911 by controlling the value for manipulating phase which the first manipulator 562 outputs to the optical phase adjusting element 911. In the case of intradyne detection, the second computing unit 571 may perform control of the frequency of local oscillation light based on the detected temperature value by switching between first control and second control with different accuracies.

In the first control, the second computing unit 571 controls the second manipulator 572 to change the value for manipulating phase if the detected temperature value falls outside a predetermined range. In the first control, in the case of intradyne detection, feedforward control by the second computing unit 571 is performed with, e.g., an accuracy lower than an accuracy which may compensate for a difference in frequency on the order of MHz between signal light and local oscillation light.

Note that, in the case of direct detection using the delay interferometer 910, the second computing unit 571 may perform control of the frequency of signal light based on the detected temperature value by switching between the first control and the second control with the different accuracies. In the first control, feedforward control by the second computing unit 571 is performed with, e.g., an accuracy lower than an accuracy which may compensate for a difference in frequency on the order of MHz between signal light and local oscillation light.

In the second control, the second computing unit 571 derives the value for manipulating phase based on the amount of change in the detected temperature value and controls the second manipulator 572 to output the derived value for manipulating phase. More specifically, relationship information indicating the relationship between an amount of change in detected temperature value and an amount of change for the value for manipulating phase is stored in the second computing unit 571. The second computing unit 571 derives an amount of change for the value for manipulating phase which compensates for the amount of change in the detected temperature value output from the temperature sensor 912 on the basis of the relationship information and controls the second manipulator 572 according to the derived amount of change for the manipulation value.

The second manipulator 572 manipulates the optical phase of the optical phase adjusting element 911 by outputting the value for manipulating phase to the optical phase adjusting element 911 under control of the second computing unit 571. For example, the second computing unit 571 outputs the value for manipulating phase as a digital signal to the second manipulator 572. The second manipulator 572 converts the value for manipulating phase output from the second computing unit 571 to an analog signal and outputs the value for manipulating phase to the optical phase adjusting element 911.

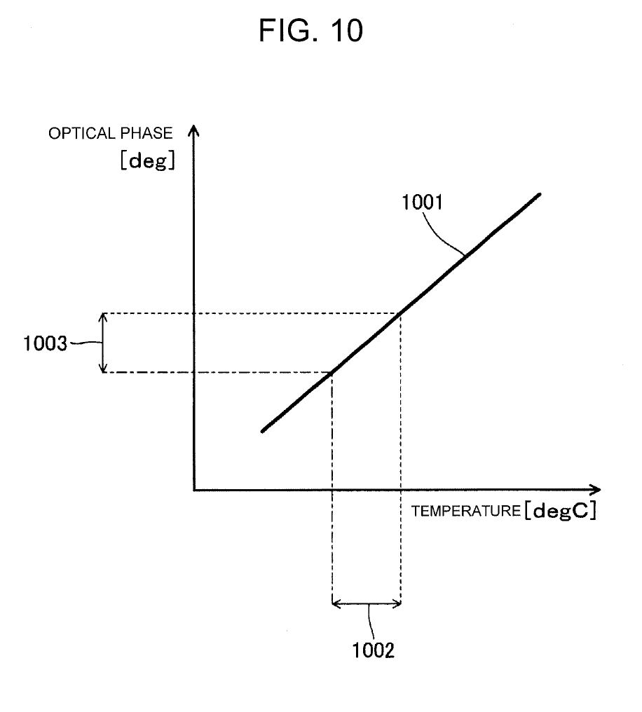

FIG. 10 is a chart depicting an example of a characteristic of optical phase versus temperature of the optical phase adjusting element. Referring to FIG. 10, the abscissa represents the temperature [degC] of the optical phase adjusting element 911 while the ordinate represents the optical phase [deg] of signal light adjusted by the optical phase adjusting element 911. A characteristic 1001 is a characteristic of optical phase versus temperature of the optical phase adjusting element 911.

For example, if the optical waveguide of the optical phase adjusting element 911 is made of glass, the optical phase (the amount of delay) of the optical phase adjusting element 911 varies substantially linearly with temperature, as indicated by the characteristic 1001. Accordingly, the ratio of a deviation 1003 in the optical phase to an amount 1002 of change in the temperature (the slope of the characteristic 1001) of the optical phase adjusting element 911 is substantially constant.

### (Specific Example of Second Control by Second Computing Unit)

In the second control by the second computing unit 571 when the first computing unit 561 is not in operation, a reference temperature value for an LD 551 is set to the detected temperature value when feedback control by the first computing unit 561 is stopped. The second computing unit 571 periodically calculates the amount of change of the current temperature of the optical phase adjusting element 911 from the temperature (reference temperature value) of the optical phase adjusting element 911 when feedback control by the first computing unit 561 is stopped.

Assume here that the ratio of the deviation 1003 in optical phase to the amount 1002 of change in the temperature (the slope of the characteristic 1001) of the optical phase adjusting element 911 depicted in FIG. 10 is 1/0.2=5 [deg/degC.]. For example, the second computing unit 571 may calculate the amount of change (the amount of deviation) of the current optical phase of the optical phase adjusting element 911 from the optical phase as the reference value of the optical phase adjusting element 911 when feedback control by the first computing unit 561 is stopped, according to, e.g., Expression (3) below.

((Current Detected Temperature Value)−(Reference Temperature Value))×5 (3)

The second computing unit 571 calculates the value for manipulating phase for compensating for the calculated amount of change in optical phase and controls the second manipulator 572 according to the calculated manipulation value. For example, relationship information indicating the relationship (e.g., the ratio) between the value for manipulating phase to be input to the optical phase adjusting element 911 and the optical phase of the optical phase adjusting element 911 is stored in the second computing unit 571.

The second computing unit 571 may calculate an amount of change for the value for manipulating phase for compensating for a change in the optical phase of the optical phase adjusting element 911 on the basis of the stored relationship information. For this reason, the optical phase of the optical phase adjusting element 911 may be kept with high accuracy at the optical phase when feedback control by the first computing unit 561 is stopped.

Note that if the maximum value of the amount of change in the temperature of the delay interferometer 910 is 2/60 [degC./sec], and the maximum allowable value of the amount of deviation in the optical phase of the optical phase adjusting element 911 is 1 [deg], the value for manipulating phase is desirably updated at intervals of 6 [sec] or less.

If the second computing unit 571 may change the value for manipulating phase according to a time constant corresponding to the speed of response of the detected temperature value to a change in the temperature of the optical phase adjusting element 911 when changing the value for manipulating phase using a calculated amount of change. The speed of response of the detected temperature value to a change in the temperature of the optical phase adjusting element 911 depends on, e.g., the transfer characteristics of heat.

The transfer characteristics of heat depend on thermal resistance and heat capacity and may be approximated by, e.g., an RC filter of an electric circuit model. Accordingly, the second computing unit 571 may change the value for manipulating phase according to a time constant corresponding to the transfer characteristics of heat. This may suppress wobbles in control of the value for manipulating phase that are caused by the transfer characteristics of heat.

### (Updating Control by Updating Control Circuit)

Updating control by the updating control circuit 501 depicted in FIG. 9 is, for example, the same as the updating control depicted in FIG. 7.

### (Modification of Optical Receiving Device)

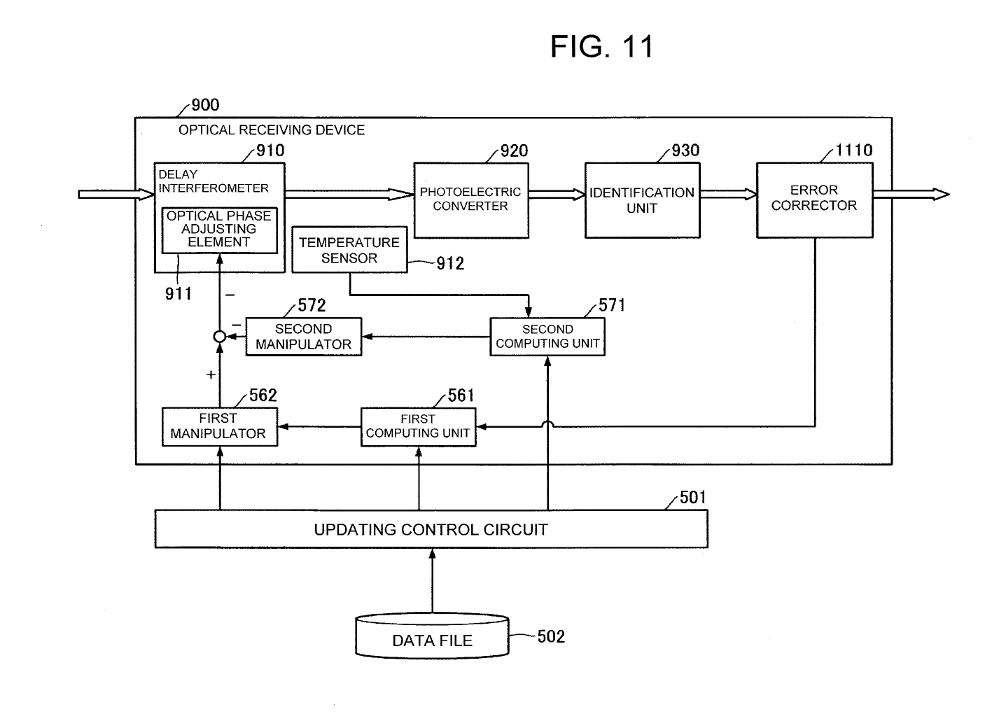

FIG. 11 is a diagram depicting a modification of the optical receiving device depicted in FIG. 9. Referring to FIG. 11, the same parts as those depicted in FIG. 9 are denoted by the same reference numerals, and a description thereof will be omitted. As depicted in FIG. 11, the optical receiving device 900 may include an error corrector 1110 instead of the Q-factor monitor 940 depicted in FIG. 9. The identification unit 930 outputs data to the error corrector 1110.

The error corrector 1110 corrects an error in data output from the identification unit 930. The error corrector 1110 outputs the data having undergone error correction. The error corrector 1110 also outputs, to the first computing unit 561, the number of errors in data output from the identification unit 930. The number of errors in data is a characteristic to be compensated for corresponding to the first characteristic 111 depicted in FIG. 1 and indicates the reception quality of signal light received by the optical receiving device 900.

The first computing unit 561 controls the phase difference between branch signal beams obtained by the delay interferometer 910 on the basis of not the Q-factor depicted in FIG. 9 but the number of errors output from the error corrector 1110 and performs feedback control that increases a Q-factor. As depicted in FIG. 11, the temperature sensor 912 may be provided outside the delay interferometer 910 to detect the ambient temperature for the delay interferometer 910. In this case as well, the temperature of the optical phase adjusting element 911 may be indirectly detected.

As described above, according to the optical receiving device 900 of the third embodiment, in feedforward control to be performed by the second computing unit 571 during updating of the function of the first computing unit 561 that performs feedback control, relationship information between a detected value and a manipulation value is used. The use improves the accuracy of feedforward control and stabilizes control of a phase difference in the optical phase adjusting element 911 even during updating of the first computing unit 561. Accordingly, communication quality may be improved.

As has been described above, a control device, an optical receiving device, and a control method each derive an amount to be manipulated using relationship information between a detected value and a manipulation value in feedforward control by the second computing unit 126 to be performed during updating of the function of the first computing unit 122 that performs feedback control. This allows high-accuracy control (with a smaller systematic error) and stabilization of control during updating of the first computing unit 122.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device comprising:
a first computing circuit which manipulates a parameter that changes a first characteristic in a processing device on the basis of a result of detecting the first characteristic of the processing device;
an updating control circuit which stops the first computing circuit from manipulating the parameter when updating a function of the first computing circuit;
an acquisition circuit which acquires relationship information indicating a relationship between an amount to be manipulated for the parameter and the amount of change in a second characteristic of the processing device that changes the first characteristic; and
a second computing circuit which manipulates the parameter by an amount to be manipulated based on the relationship information acquired by the acquisition circuit and the amount of change in a result of detecting the second characteristic, while the first computing circuit is stopped from manipulating the parameter by the updating control circuit.

2. The control device according to claim 1, wherein the second computing circuit derives the amount to be manipulated for the parameter which compensates for the amount of change in the result of detecting the second characteristic, on the basis of the relationship information and manipulates the parameter by the derived amount to be manipulated.

3. The control device according to claim 2, wherein the second computing circuit uses, as a reference value, the result of detecting the second characteristic when the first computing circuit is stopped from manipulating the parameter and derives the amount to be manipulated that compensates for the amount of change of the result of detecting the second characteristic from the reference value.

4. The control device according to claim 1, wherein
the parameter includes a first parameter and a second parameter, and
the updating control circuit adjusts the first parameter and the second parameter on the basis of the first parameter when the first computing circuit is stopped from manipulating the parameter and a variable range of the first parameter.

5. The control device according to claim 4, wherein the updating control circuit adjusts the first parameter and the second parameter such that respective variable ranges for an increasing direction and a decreasing direction of the first parameter are not less than threshold values.

6. The control device according to claim 1, wherein
the second characteristic includes a third characteristic and a fourth characteristic,
the parameter includes a first parameter that changes the third characteristic and a second parameter that changes the fourth characteristic, and
the updating control circuit adjusts the first parameter and the second parameter on the basis of a result of detecting the third characteristic when the first computing circuit is stopped from manipulating the parameter and a variable range of the third characteristic.

7. The control device according to claim 6, wherein the updating control circuit adjusts the first parameter and the second parameter such that respective variable ranges for an increasing direction and a decreasing direction of the third characteristic are not less than threshold values.

8. The control device according to claim 1, wherein
the updating control circuit
causes the second computing circuit to perform first control that manipulates the parameter without the relationship information, while the function of the first computing circuit is not updated and
causes the second computing circuit to perform second control that manipulates the parameter by the amount to be manipulated based on the relationship information and the amount of change in the result of detecting the second characteristic, while the function of the first computing circuit is updated.

9. An optical receiving device which causes signal light and local oscillation light to interfere with each other and digitally processes an interference result, comprising:
a first computing circuit which changes a manipulation value giving an instruction to manipulate at least one of temperature of a semiconductor laser generating the local oscillation light and drive current to the semiconductor laser on the basis of a result of detecting a phase difference between the signal light and the local oscillation light;
an updating control circuit which stops the first computing circuit from manipulating the manipulation value when updating a function of the first computing circuit;
an acquisition circuit which acquires relationship information indicating a relationship between an amount to be manipulated for the manipulation value and the amount of change in at least one of the temperature and magnitude of the drive current to the semiconductor laser; and
a second computing circuit which changes the manipulation value by an amount to be manipulated based on the relationship information acquired by the acquisition circuit and the amount of change in a result of detecting the at least one of the temperature and the magnitude of the drive current, while the first computing circuit is stopped from manipulating the manipulation value by the updating control circuit.

10. The optical receiving device according to claim 9, wherein the second computing circuit changes the manipulation value according to a predetermined time constant.

11. An optical receiving device which includes a delay interferometer branching signal light, adjusting a phase difference between branch signal beams, and causing the signal beams to interfere with each other and identifies data indicated by the signal light on the basis of an interference result from the delay interferometer, comprising:
a first computing circuit which changes a manipulation value giving an instruction to manipulate the phase difference on the basis of a result of detecting reception quality of the signal light that is based on the interference result;
an updating control circuit which stops the first computing circuit from manipulating the manipulation value when updating a function of the first computing circuit;
an acquisition circuit which acquires relationship information indicating a relationship between an amount to be manipulated for the manipulation value and the amount of change in temperature of the delay interferometer; and
a second computing circuit which changes the manipulation value by an amount to be manipulated based on the relationship information acquired by the acquisition circuit and the amount of change in a result of detecting the temperature, while the first computing circuit is stopped from manipulating the manipulation value by the updating control circuit.

12. The optical receiving device according to claim 11, wherein the second computing circuit changes the manipulation value according to a predetermined time constant.

13. A control method comprising:
manipulating, by a first computing circuit, a parameter which changes a first characteristic in a processing device on the basis of a result of detecting the first characteristic of the processing device;
stopping the first computing circuit from manipulating the parameter when updating a function of the first computing circuit;
acquiring relationship information indicating a relationship between an amount to be manipulated for the parameter and the amount of change in a second characteristic of the processing device that changes the first characteristic; and
manipulating the parameter by an amount to be manipulated based on the acquired relationship information and the amount of change in a result of detecting the second characteristic, while the first computing circuit is stopped from manipulating the parameter.
